(19) United States
(12) Patent Application Publication
(10) Pub. No.: US 2021/0311001 A1
(43) Pub. Date: Oct. 7, 2021

(54) INFORMATION PROCESSING APPARATUS, CONTROL METHOD OF INFORMATION PROCESSING APPARATUS, AND COMPUTER-READABLE STORAGE MEDIUM THEREFOR

(71) Applicant: CANON KABUSHIKI KAISHA, Tokyo (JP)

(72) Inventors: Hidetaka Kawamura, Kanagawa (JP); Akihiro Taya, Kanagawa (JP); Yutaka Yoshimasa, Kanagawa (JP)

(21) Appl. No.: 17/351,787

(22) Filed: Jun. 18, 2021

Related U.S. Application Data
(63) Continuation of application No. PCT/JP2019/049158, filed on Dec. 16, 2019.

(30) Foreign Application Priority Data
Dec. 20, 2018 (JP) 2018-238829

(51) Int. Cl. G01N 30/86; G01N 21/33; G01N 21/3577; G01N 21/64; G01N 21/65; G01N 23/223; G01N 23/083; G01N 23/20; G06N 20/00; G06N 5/04

(52) U.S. Cl. CPC G01N 30/8693; G01N 21/33; G01N 21/3577; G01N 21/64; G06N 5/04; G01N 23/223; G01N 23/083; G01N 23/20; G06N 20/00; G01N 21/65

(57) ABSTRACT

An information processing apparatus assists a user in determining quantitative information of a test substance estimated by using a learning model. The information processing apparatus has an information acquisition means and a reliability acquisition means. The information acquisition means acquires the quantitative information of the test substance estimated by inputting spectral information of a sample including the test substance and impurities into the learning model. The reliability acquisition means acquires reliability of the acquired quantitative information of the test substance.

### CROSS-REFERENCE TO RELATED APPLICATIONS

This application is a Continuation of International Patent Application No. PCT/JP2019/049158, filed Dec. 16, 2019, which claims the benefit of Japanese Patent Application No. 2018-238829, filed Dec. 20, 2018, both of which are hereby incorporated by reference herein in their entirety.

### BACKGROUND OF THE INVENTION

### Field of the Invention

The present invention relates to an information processing apparatus, a control method of the information processing apparatus, and a computer-readable storage medium therefor.

### Description of the Related Art

Spectral analysis is widely used as a method of knowing the concentration or amount of a specific component (hereinafter, referred to as “test substance”) contained in various samples. The spectral analysis enables detection of a response generated when a stimulus of some kind is given to the sample, so that information (spectral information) about the components constituting the sample is able to be obtained on the basis of the obtained signal. The spectral information is the number of counted fragments each having a temperature, a mass, and a specific mass, as well as the intensity of electromagnetic waves including light, which characterize the stimulus and response. The spectral analysis also includes using an electron impact as a stimulus to record the amount of the mass of the fragments generated by decomposition and to obtain information such as a structure.

For the spectral analysis, there is a method of performing analysis by irradiation with electromagnetic waves after attempting separation by using a difference between components in three-dimensional size, charge, hydrophilicity or hydrophobicity, or the like in advance. It is called separation analysis. For example, in liquid chromatography (hereinafter, referred to as HPLC), a test substance is separated from other substances (hereinafter, referred to as impurities) by optimizing analytical conditions such as column species, mobile phase species, temperature, flow velocity, and the like. Then, the concentration and amount are able to be known by measuring the spectrum of the separated test substance. In addition, in the case where it is difficult to separate the test substance from impurities, pretreatment of removing a part of impurities may be performed in advance, or optimization of separation conditions may be considered. Unless separation from impurities can be achieved even by the pretreatment or optimization of separation conditions, peak splitting by arithmetic processing is attempted.

As a conventional peak splitting method, there are a method of setting a baseline, a method of vertically splitting by using a minimum value between peaks, and a method of fitting and splitting an appropriate function such as a Gaussian function by using the least-squares method described in Japanese Patent Application Laid-Open No. H06-324029 and Japanese Patent Application Laid-Open No. 2006-177980.

In this respect, HPLC is often used for the analysis of biological samples. Since there are many impurities in biological samples such as urine and blood and there are cases where unknown impurities derived from ingesta are contained, however, an operator is required who is familiar with consideration of separation conditions for separating a test substance from impurities, pretreatment, and peak splitting methods, and the like.

In addition, there are many cases in which samples contain a large amount of impurities, such as in an analysis of pesticide residues in food and environmental analysis. Therefore, there has been a strong demand for a method that allows even a beginner to analyze a test substance in an impurity sample easily and accurately without the need for pretreatment.

As mentioned above, conventionally, in order to acquire quantitative information such as the concentration and amount of a test substance from spectral information, pretreatment for separating impurities and arithmetic processing such as a peak splitting method are required. Therefore, it is conceivable that a user uses a learning model based on the spectral information of a sample including the test substance to calculate quantitative information. The user determines whether the calculation result is accurate on the basis of experience and the like, and if the calculation result remains uncertain, the user changes the analytical conditions or the pretreatment, and repeats the flow of calculation from the analysis again. Therefore, even if the calculation result is inaccurate, the calculated value may be adopted as it is, or on the contrary, unnecessary reanalysis may be performed.

An object of the present invention is to assist a user in determining quantitative information of a test substance estimated by using a learning model.

It is to be noted that the object of the present invention is not limited to the above object, and one of other objects of the disclosure of this specification is to achieve functions/effects that are derived from the configurations described later in the description of embodiments and that cannot be achieved by conventional techniques.

### SUMMARY OF THE INVENTION

An information processing apparatus according to the present invention includes the following components. Specifically, the information processing apparatus includes: an information acquisition means for acquiring quantitative information of a test substance that is estimated by inputting spectral information of a sample containing the test substance and impurities into a learning model; and a reliability acquisition means for acquiring reliability of the acquired quantitative information on the test substance.

Further features of the present invention will become apparent from the following description of exemplary embodiments with reference to the attached drawings

### BRIEF DESCRIPTION OF THE DRAWINGS

FIG. 1 is a diagram illustrating an example of an overall configuration of an information processing system including an information processing apparatus according to a first embodiment.

FIG. 2 is a diagram illustrating an example of a flowchart of a processing procedure related to generation of a learning model in the first embodiment.

FIG. 3 is a diagram illustrating an example of a flowchart of a processing procedure for acquiring reliability in the first embodiment.

FIG. 4A is a diagram illustrating an example of spectral information of a sample in the first embodiment.

FIG. 4B is a diagram illustrating an example of spectral information of a sample in the first embodiment.

FIG. 5 is a diagram illustrating an example of a correspondence between a A value and a correlation coefficient in the first embodiment.

FIG. 6 is a diagram illustrating an example of a screen for displaying quantitative information and reliability of a test substance in the first embodiment.

FIG. 7 is a diagram illustrating an example of an overall configuration of an information processing system including an information processing apparatus according to a second embodiment.

FIG. 8 is a diagram for describing a classification learning model in the second embodiment.

FIG. 9A is a diagram illustrating a simulation result of Example 1.

FIG. 9B is a diagram illustrating a simulation result of Example 2.

FIG. 9C is a diagram illustrating a simulation result of Example 3.

### DESCRIPTION OF THE EMBODIMENTS

Hereinafter, forms for carrying out the present invention (embodiments) will be described with reference to drawings. The scope of the present invention, however, is not limited to the embodiments described below.

### First Embodiment

First, terms are described before describing a first embodiment.

### Sample

A sample in this embodiment is a mixture containing a plurality of types of compounds. In this embodiment, it is assumed that the sample contains a test substance and other substances (impurities). As long as the sample is a mixture, it is not particularly limited. In addition, the components of the mixture need not be identified, and unknown components may be contained. For example, it may be a biological mixture such as blood, urine, or saliva, or may be food or drink. Analysis of a biological sample includes clues to the nutrition or health status of a sample donor, and therefore the analysis is medically and nutritionally valuable. For example, urinary vitamin B3 is associated with the metabolism of sugars, lipids, and proteins and with energy production, and therefore measurement of its urinary metabolite, N1-methyl-2-pyridone-5-carboxamide, is useful for nutritional guidance for maintaining health.

### Test Substance

A test substance in this embodiment is one or more known components contained in a sample. For example, the test substance is of at least one type selected from a group consisting of proteins, DNA, viruses, fungi, water-soluble vitamins, fat-soluble vitamins, organic acids, fatty acids, amino acids, sugars, agrichemicals, and environmental hormones.

For example, if it is required to know the amount of nutrients, the test substance is thiamine (vitamin B1), riboflavin (vitamin B2), N1-methylnicotinamide, which is a metabolite of vitamin B3, N1-methyl-2-pyridone-5-carboxamide, 4-pyridoxine acid, which is a metabolite of vitamin B6, or the like. In addition, there are water-soluble vitamins such as N1-methyl-4-pyridone-3-carboxamide, pantothenic acid (vitamin B5), pyridoxin (vitamin B6), biotin (vitamin B7), pteroylmonoglutamic acid (vitamin B9), cyanocobalamin (vitamin B12), and ascorbic acid (vitamin C). Further, there are amino acids such as L-tryptophan, lysine, methionine, phenylalanine, threonine, valine, leucine, isoleucine, and L-histidine. Moreover, the test substance may be minerals such as sodium, potassium, calcium, magnesium, and phosphorus.

### Quantitative Information

The quantitative information in this embodiment is at least one selected from a group consisting of the amount of test substance contained in a sample, the concentration of the test substance contained in the sample, and the presence or absence of the test substance in the sample. In addition, it is at least one selected from a group consisting of a ratio of the concentration or amount of the test substance contained in the sample to the reference amount of the test substance and a ratio of the amount or concentration of the test substance contained in the sample.

### Spectral Information

Spectral information in this embodiment is of at least one type selected from a group consisting of a chromatogram, a photoelectron spectrum, an infrared absorption spectrum (IR spectrum), a nuclear magnetic resonance spectrum (NMR spectrum), a fluorescence spectrum, an X-ray fluorescence spectrum, an ultraviolet/visible absorption spectrum (UV/Vis spectrum), a Raman spectrum, an atomic absorption spectrum, a flame emission spectrum, an emission spectroscopy spectrum, an X-ray absorption spectrum, an X-ray diffraction spectrum, a paramagnetic resonance absorption spectrum, an electron spin resonance spectrum, a mass spectrum, and a thermal analysis spectrum.

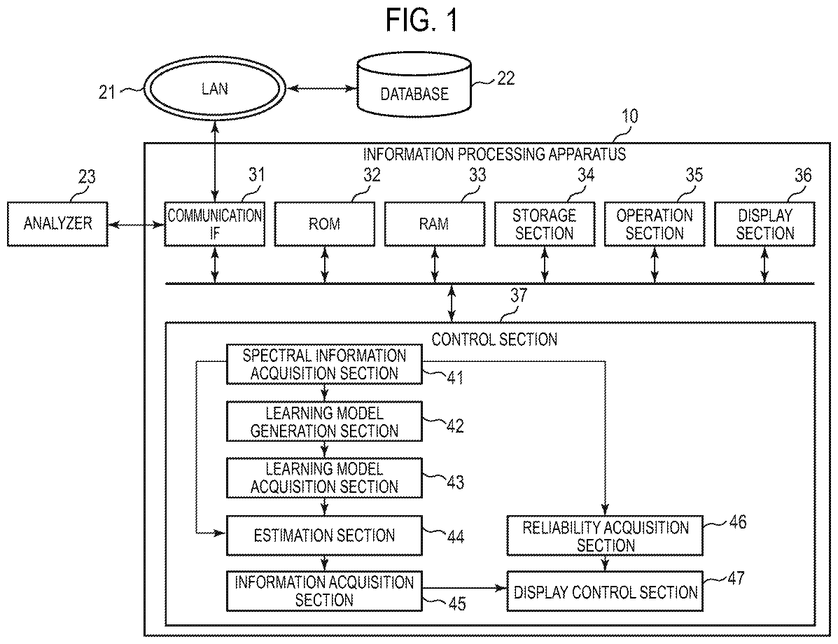

Subsequently, the information processing system in this embodiment will be described with reference to FIG. 1. FIG. 1 is a diagram illustrating an overall configuration of an information processing system including an information processing apparatus according to the first embodiment.

The information processing system in this embodiment includes an information processing apparatus 10, a database 22, and an analyzer 23. The information processing apparatus 10 and the database 22 are connected to each other so as to be able to communicate with each other via a communication means. In this embodiment, the communication means is composed of a local area network (LAN) 21. In addition, the information processing apparatus 10 and the analyzer 23 are connected via a standard communication means such as a universal serial bus (USB). The LAN may be a wired LAN, a wireless LAN, or a WAN. Furthermore, the USB may be a LAN.

The database 22 manages spectral information acquired by analysis with the analyzer 23. In addition, the database 22 manages a learning model (pre-trained model) generated by a learning model generation section 42 described later. The information processing apparatus 10 acquires the spectral information and the learning model managed by the database 22 via the LAN 21.

The learning model in this embodiment is a regression learning model, and a model generated by machine learning such as deep learning is able to be used as the learning model. A machine learning algorithm that is trained by using teacher data and constructed so as to be able to make appropriate predictions is referred to as a learning model here. There are various types of machine learning algorithms used for learning models. For example, deep learning using a neural network is able to be used. The neural network consists of an input layer, an output layer, and a plurality of hidden layers, where the respective layers are connected to each other by a calculation formula called an activation function. When using teacher data with a label (output corresponding to the input), the coefficient of the activation function is determined so that the relationship between the input and the output is established. Determination of the coefficients with a plurality of pieces of teacher data enables generation of a learning model capable of predicting the output for the input with high accuracy.

The analyzer 23 is a device for use in analyzing samples, test substances, and the like. The analyzer 23 corresponds to an example of an analytical means. As described above, in this embodiment, the information processing apparatus 10 and the analyzer 23 are communicably connected to each other. The analyzer 23, however, may be provided inside the information processing apparatus 10, or the information processing apparatus 10 may be provided inside the analyzer 23. Furthermore, the analysis result (spectral information) may be passed from the analyzer 23 to the information processing apparatus 10 via a recording medium such as a non-volatile memory.

The analyzer 23 in this embodiment is not limited as long as it is able to acquire spectral information, and a device using a chemical analysis method or a physical analysis method is able to be used for the analyzer 23. In this embodiment, the device using a chemical analysis method uses at least one type of method selected from a group consisting of, for example, chromatography such as liquid chromatography or gas chromatography and capillary electrophoresis. In this embodiment, the device using the physical analysis method uses at least one type of method selected from a group consisting of, for example, photoelectron spectroscopy, infrared absorption spectroscopy, nuclear magnetic resonance spectroscopy, fluorescence spectroscopy, X-ray fluorescence spectroscopy, visible/ultraviolet absorption spectroscopy, Raman spectroscopy, atomic absorption spectroscopy, flame emission spectroscopy, emission spectroscopy, X-ray absorption spectroscopy, X-ray diffractometry, electron spin resonance spectroscopy using paramagnetic resonance absorption or the like, mass spectrometry, and a thermal analysis method.

For example, the device using the liquid chromatography is equipped with a mobile phase container, a liquid feed pump, a sample injection unit, a column, a detector, and an A/D converter. As the detector, there is used an electromagnetic wave detector that uses ultraviolet rays, visible light, infrared rays, or the like, an electrochemical detector, an ion detector, and the like. In this case, the resulting spectral information is the intensity of an output from the detector over time.

The information processing apparatus 10 includes a communication IF 31, a ROM 32, a RAM 33, a storage section 34, an operation section 35, a display section 36, and a control section 37 as its functional components.

The communication IF (interface) 31 is implemented by, for example, a LAN card and a USB interface card. The communication IF 31 controls communication between external devices (for example, the database 22 and the analyzer 23) and the information processing apparatus 10 via the LAN 21 and the USB. The ROM (read-only memory) 32 is implemented by a non-volatile memory or the like and stores various programs or the like. The RAM (random access memory) 33 is implemented by a volatile memory or the like and temporarily stores various information. The storage section 34 is implemented by, for example, an HDD (hard disk drive) or the like and stores various information. The operation section 35 is implemented by, for example, a keyboard, a mouse, or the like, and an instruction from the user is input into the apparatus. The display section 36 is implemented by, for example, a display or the like, and displays various information to the user. The operation section 35 and the display section 36 provide functions as GUI (graphical user interface) under the control of the control section 37.

The control section 37 is implemented by, for example, at least one CPU (central processing unit) and integrally controls the processing in the information processing apparatus 10. The control section 37 includes a spectral information acquisition section 41, a learning model generation section 42, a learning model acquisition section 43, an estimation section 44, an information acquisition section 45, a reliability acquisition section 46, and a display control section 47 as its functional components.

The spectral information acquisition section 41 acquires an analysis result of a sample including at least a test substance and impurities, which is specifically spectral information of the sample, from the analyzer 23. In addition, the spectral information of the sample may be acquired from the database 22 in which the analysis result is stored in advance. Furthermore, the spectral information of the test substance is acquired in the same manner. The spectral information of the test substance is spectral information obtained in the case where a single test substance is present. Then, the spectral information acquisition section 41 outputs the acquired spectral information of the sample to the estimation section 44 and to the reliability acquisition section 46. Moreover, the acquired spectral information of the test substance is output to the learning model generation section 42 and to the reliability acquisition section 46.

The learning model generation section 42 generates teacher data by using the spectral information of the test substance acquired by the spectral information acquisition section 41. Then, the learning model generation section 42 performs deep learning by using the teacher data and generates a learning model. The generation of the teacher data and the generation of the learning model will be described later in detail. Then, the learning model generation section 42 outputs the generated learning model to the learning model acquisition section 43. In addition, the learning model generation section 42 may output the generated learning model to the database 22.

The learning model acquisition section 43 acquires the learning model generated by the learning model generation section 42. If the learning model is stored in the database 22, the learning model acquisition section 43 acquires the learning model from the database 22. Then, the learning model acquisition section 43 outputs the acquired learning model to the estimation section 44.

The estimation section 44 causes the learning model to estimate the quantitative information of the test substance contained in the sample by inputting the spectral information of the sample acquired by the spectral information acquisition section 41 into the learning model acquired by the learning model acquisition section 43. Then, the estimation section 44 outputs the estimated quantitative information to the information acquisition section 45. The estimation section 44 corresponds to an example of an estimation means for estimating quantitative information of a test substance by inputting spectral information of a sample into a learning model.

The information acquisition section 45 acquires the quantitative information estimated by the learning model. In other words, the information acquisition section 45 corresponds to an example of an information acquisition means for acquiring quantitative information of a test substance that is estimated by inputting spectral information of a sample containing the test substance and impurities into a learning model. Then, the information acquisition section 45 outputs the acquired quantitative information to the display control section 47.

The reliability acquisition section 46 acquires the reliability of the quantitative information of the test substance acquired by the information acquisition section 45. In other words, the reliability acquisition section 46 corresponds to an example of a reliability acquisition means for acquiring reliability of the acquired quantitative information on the test substance. The reliability in this embodiment is an index indicating how much the quantitative information of the test substance estimated by the learning model can be trusted. The acquisition of the reliability will be described later in detail. Then, the reliability acquisition section 46 outputs the acquired reliability to the display control section 47.

The display control section 47 causes the display section 36 to display the quantitative information acquired by the information acquisition section 45 and the reliability acquired by the reliability acquisition section 46. The display control section 47 corresponds to an example of the display control means.

At least some of the respective units of the control section 37 may be implemented as independent devices. In addition, each of some units may be implemented as software that implements each function. In this case, the software that implements the function may run on a server via a cloud or any of other networks. In this embodiment, it is assumed that each unit is implemented by software in a local environment.

The configuration of the information processing system illustrated in FIG. 1 is merely an example. For example, the storage section 34 of the information processing apparatus 10 may include the function of the database 22, and the storage section 34 may retain various information.

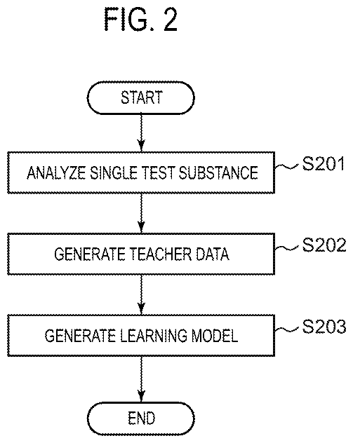

Subsequently, the processing procedure in this embodiment will be described with reference to FIGS. 2 to 6.

FIG. 2 is a flowchart of a processing procedure related to generation of a learning model.

### (S201) (Analyzing Single Test Substance)

In step S201, the analyzer 23 analyzes a single test substance and acquires the spectral information of the test substance. Analytical conditions may be selected as appropriate from the viewpoints of sensitivity and analysis time. At that time, the analyzer 23 analyzes the test substance by changing variation of the concentration of the test substance in several ways. How many variations of the concentration of test substances are needed depends on the nature or the like of the substances. In general, however, it is desirable to change variation of the concentration of the test substance three points or more. In the case where there is a plurality of types of test substances, it is desirable to analyze the test substances for each type of the test substance. If, however, the signals of the test substances are sufficiently separated from each other, the test substances may be analyzed at the same time. Then, the analyzer 23 outputs the acquired spectral information to the information processing apparatus 10. The information processing apparatus 10 receives the spectral information from the analyzer 23 and retains the spectral information in the RAM 33 or the storage section 34. The spectral information acquisition section 41 acquires the spectral information thus retained. As mentioned above, the analytical result, spectral information, may be retained in the database 22. In this case, the spectral information acquisition section 41 acquires the spectral information from the database 22. In addition, the timing at which the analyzer 23 analyzes the test substance may be any timing as long as it is performed before the generation of the teacher data in step S202.

### (S202) (Generating Teacher Data)

In step S202, the learning model generation section 42 generates a plurality of pieces of teacher data by using the spectral information of the test substance acquired by the spectral information acquisition section 41. The method of generating the teacher data will be specifically described. The teacher data is generated by adding an arbitrary waveform generated by random numbers to the spectral information of the test substance. For example, in the liquid chromatography, the waveform indicated by the spectral information (chromatogram) often has a Gaussian distribution. Therefore, the learning model generation section 42 adds a plurality of Gaussian curves (Gaussian functions) whose peak height, median, and standard deviation are determined by random numbers to generate a plurality of random noises.

The spectral information does not need to be prepared throughout the retention time (the time it takes for a compound to be detected by the detector from an injection of the sample). It is only required to prepare trimmed data with the peak of the test substance in the center. The wider the trimming range, the higher the accuracy in quantifying by a calculation section described later, but the number of pieces of teacher data required to increase the accuracy increases. The trimming range is preferably 6 times or more to 30 times or less of the standard deviation (σ) of the test substance peak, more preferably 10 times or more to 20 times or less, and even more preferably 14 times or more to 18 times or less.

Subsequently, an arbitrary waveform is added to the trimmed data. The number of waveforms to be added is preferably a number that is likely cause the peaks to be not separated on the chromatogram and to overlap each other, but is usually preferably two or more to eight or less. If the number of waveforms to be added exceeds eight, it becomes difficult to predict the shape of the peak of the test substance, and a quantitative accuracy may decrease. If the number of waveforms to be added is less than two, quantification may not be accurately performed on the chromatogram with overlapping peaks. The number of waveforms to be added is more preferably three or more to six or less, and even more preferably four or more to five or less. The shape of the arbitrary waveform is assumed to be of a Gaussian function expressed by Equation 1 below.

$$a exp \{ - \frac{{( x - b )}^{2}}{2 {c}^{2}} \} \qquad ( Equation 1 )$$

where a is determined by a random number in a range of 0 to α% with respect to the expected peak height of the test substance, and b is determined by a random number in a range of up to β% with respect to the trimmed range. For example, in the case where the range of ±8σ is trimmed with respect to the center of the peak of the test substance, b is an arbitrary value in a range of −8σ×β% to +8σ×β%. The values α and β are preferably 50 or more to 300 or less, more preferably 50 or more to 250 or less, and further preferably 50 or more to 200 or less. The value c is determined by a random number in a range of preferably 0.1 times or more to 10 times or less, more preferably 0.2 times or more to 8 times or less, and further preferably 0.5 times or more to 5 times or less of the standard deviation of the test substance peak.

The learning model generation section 42 generates a plurality of waveforms generated by adding each of the plurality of random noises to the waveform indicated by the spectral information of the test substance. The plurality of waveforms generated in this manner is used as spectral information (learning spectral information) of a virtual sample containing a test substance and impurities. In other words, the plurality of pieces of generated spectral information is determined as input data that constitutes teacher data. Furthermore, the learning model generation section 42 determines the peak height (quantitative information) identified from the spectral information of the test substance, which is the basis of the generated spectral information, as correct answer data constituting the teacher data. In this manner, the learning model generation section 42 generates the plurality of pieces of teacher data, which is a pair of input data and correct answer data. In addition, since the learning model generation section 42 acquires spectral information according to the concentration of the test substance in step S201, the plurality of pieces of teacher data is generated for each concentration. It should be noted that the peak width of the chromatogram waveform tends to increase as the retention time increases and therefore the learning model generation section 42 may widen the width of the generated waveform.

Japanese Patent Application Laid-Open No. 2018-152000 discloses a method of performing machine learning by associating the mass spectral data of a specimen with the presence or absence of cancer. A large amount of teacher data, however, is required to increase the accuracy of machine learning. In Japanese Patent Application Laid-Open No. 2018-152000, 90,000 kinds of data are prepared as teacher data. In other words, machine learning enables complex analysis results to be analyzed with high accuracy, while it has a disadvantage that it is necessary to prepare a large amount of teacher data. In this embodiment, it is not necessary to prepare a large amount of teacher data, which is the disadvantage of the machine learning, thereby enabling a reduction in the burden on a user.

Although the teacher data is generated as described above, the spectral information of the sample for learning may be acquired by analyzing a plurality of samples with the analyzer 23 and may be used as teacher data together with the quantitative information of the test substance. In addition, spectral information of a virtual sample may be generated by a method different from the method described above.

### (S203) (Generating Learning Model)

In step S203, the learning model generation section 42 generates a learning model by performing machine learning according to a predetermined algorithm by using the plurality of pieces of teacher data generated for each concentration in step S202. In this embodiment, a neural network is used as the predetermined algorithm. The learning model generation section 42 generates a learning model that estimates the quantitative information of a test substance contained in a sample on the basis of the input of the spectral information of the sample by causing the neural network to learn by using the plurality of pieces of teacher data. Since the learning method of the neural network is a well-known technique, detailed description is omitted in this embodiment. In addition, as a predetermined algorithm, for example, SVM (support vector machine), DNN (deep neural network), CNN (convolutional neural network), or the like may be used. In the case where there are multiple types of test substances, the learning model generation section 42 constructs a learning model for each substance. Then, the learning model generation section 42 stores the generated learning model into the RAM 33, the storage section 34, or the database 22.

As described above, a learning model that estimates the quantitative information of the test substance contained in the sample is generated on the basis of the spectral information of the sample.

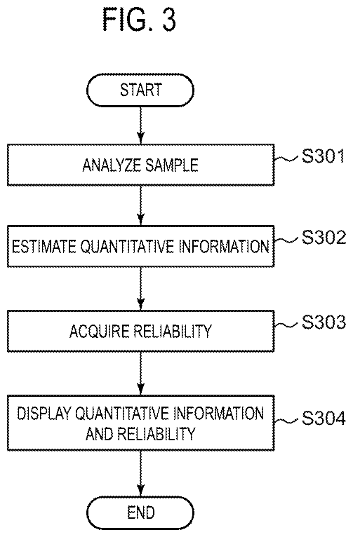

Subsequently, the method of acquiring reliability will be described. FIG. 3 is a flowchart illustrating a processing procedure for acquiring the reliability.

### (S301) (Analyzing Sample)

In step S301, the analyzer 23 analyzes a target sample and acquires the spectral information of the sample. The analytical conditions are assumed to be the same as in step S201 described above. Then, the analyzer 23 outputs the acquired spectral information to the information processing apparatus 10. The information processing apparatus 10 receives the spectral information from the analyzer 23 and stores the spectral information into the RAM 33 or the storage section 34 for retention. The spectral information acquisition section 41 acquires the spectral information thus retained. As mentioned above, the analytical result, spectral information, may be retained in the database 22. In this case, the spectral information acquisition section 41 acquires the spectral information from the database 22. In addition, the timing at which the analyzer 23 analyzes the sample may be any timing as long as the analysis is performed before the estimation of the quantitative information in step S302.

### (S302) (Estimating Quantitative Information)

In step S302, the learning model acquisition section 43 acquires the learning model stored in the RAM33, the storage section 34, or the database 22. Then, the estimation section 44 causes the acquired learning model to estimate the quantitative information of the test substance contained in the sample by inputting the spectral information of the sample acquired in step S301. Moreover, if necessary, the estimation section 44 converts the estimated quantitative information into the format displayed in the display section 36. The format to be displayed in the display section 36 may be a concentration of g/L, mol/L, or the like or may be a ratio to the reference amount (standard amount). As long as the value estimated by the learning model is in any of these display formats, there is no need to convert the value. Then, the information acquisition section 45 acquires the estimated quantitative information from the estimation section 44 and stores the quantitative information into the RAM 33 or the storage section 34.

As described above, even if the peak of the test substance is not completely separated from the peak of impurities, the use of the learning model acquired by machine learning enables the quantitative information of the test substance to be accurately acquired without complicated and advanced knowledge about analysis. As a result, even a non-expert is able to easily perform highly-accurate quantitative analysis of a test sub stance.

### (S303) (Acquiring Reliability)

In step S303, the reliability acquisition section 46 acquires the reliability of the quantitative information estimated in step S302. A method of acquiring the reliability will be described in detail.

The reliability acquisition section 46 acquires the spectral information of the test substance output by the spectral information acquisition section 41. Then, the reliability acquisition section 46 identifies the retention time (first retention time) of the peak (first peak) identified from the spectral information of the test substance. Subsequently, the reliability acquisition section 46 acquires the spectral information of the sample output by the spectral information acquisition section 41. Then, the reliability acquisition section 46 identifies the peak (second peak) having a retention time closest to the retention time of the first peak from the spectral information of the sample. The reliability acquisition section 46 calculates a time difference between the retention time of the first peak and the retention time of the second peak identified as described above, and takes the calculated time difference as a Δ value. Alternatively, the Δ value may be used as a time difference between the retention time at the center of the full width at half maximum in the spectral information of the test substance and the retention time at the center of the full width at half maximum at the second peak of the spectral information of the sample.

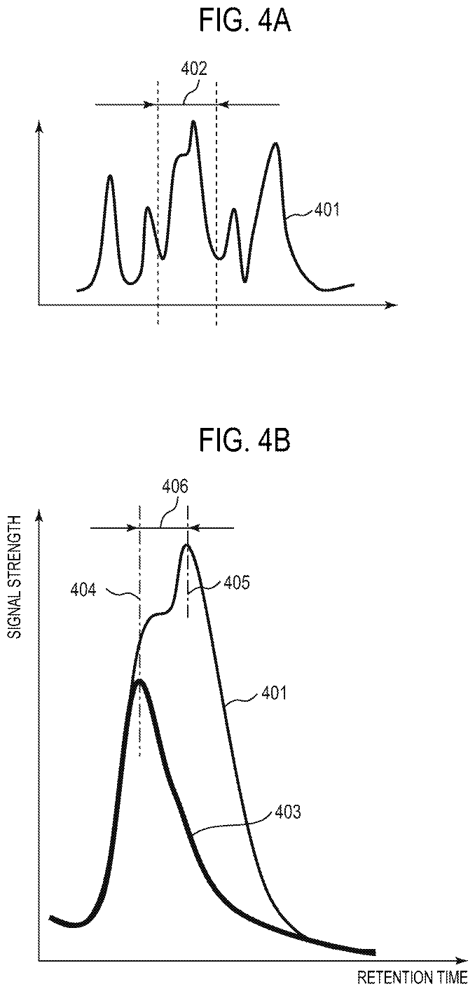

FIG. 4A illustrates spectral information 401 of the sample acquired from the spectral information acquisition section 41. The spectral information 401 of the sample illustrated in FIGS. 4A and 4B is a chromatogram with the vertical axis indicating the signal strength and the horizontal axis indicating the retention time. FIG. 4B illustrates an extracted range of the spectral information 401, as indicated by 402. In FIG. 4B, for the sake of description, spectral information 403 of the test substance in the same range is superimposed. The reliability acquisition section 46 identifies the first peak 404 from the spectral information 403 of the test substance. Then, the reliability acquisition section 46 identifies the second peak 405 having a retention time closest to the retention time of the first peak. A time difference 406 between the retention time of the first peak and the retention time of the second peak is the Δ value.

Subsequently, the reliability acquisition section 46 generates a plurality of pieces of spectral information of a virtual sample containing a test substance and impurities, which has the same Δ value as the calculated Δ value. This generation method is similar to the method described in step S202. Then, the reliability acquisition section 46 inputs the plurality of pieces of generated spectral information to the learning model acquired in step S302 and estimates the quantitative information of the test substance contained in the virtual sample for each piece of the generated spectral information. In this specification, the estimated quantitative information is referred to as “estimated value.” In addition, the height of the peak (quantitative information) identified from the spectral information of the test substance used in the generation of the spectral information of the virtual sample is referred to as “correct answer value.” The reliability acquisition section 46 calculates a correlation coefficient between the plurality of estimated values and correct answer values and uses the calculated correlation coefficient as the reliability of the quantitative information estimated in step S302. The reliability acquisition section 46 acquires the reliability calculated in this manner and stores the reliability into the RAM 33 or the storage section 34.

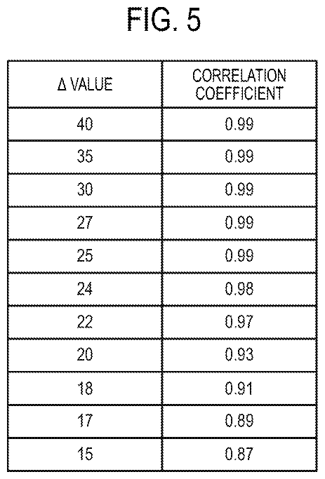

Although the correlation coefficient is calculated in step S303 in this embodiment, the correlation coefficient may be calculated in advance for each Δ value. FIG. 5 is a diagram illustrating a result of calculating the correlation coefficient for each Δ value. In the case where the correlation coefficient is calculated in advance, the reliability acquisition section 46 searches the column of Δ values in FIG. 5 for the same value as the time difference (Δ value) between the retention time of the first peak and the retention time of the second peak. If the same value is found as a result of the search, the reliability acquisition section 46 acquires the correlation coefficient corresponding to that value from the correlation coefficient column and uses the acquired correlation coefficient as reliability. Unless the same value is found, the reliability acquisition section 46 may identify the value closest to the calculated Δ value from the column of Δ values in FIG. 5.

### (S304) (Displaying Quantitative Information and Reliability)

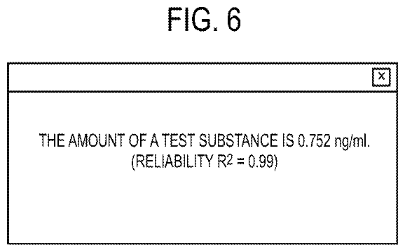

In step S304, the display control section 47 causes the display section 36 to display the quantitative information of the test substance contained in the sample estimated by the learning model in step S302 and the reliability calculated in step S303. On that occasion, the quantitative information and the reliability may be arranged and displayed in a graph format or a tabular format. FIG. 6 illustrates an example of the screen (window) displayed in the display section 36. Furthermore, the level may be displayed according to the reliability value such as “high” or “low.” If the calculated reliability is higher than a predetermined threshold value, the display form of the estimated quantitative information such as color, character thickness, and character size may be changed. The same applies when the calculated reliability is lower than the predetermined threshold value.

The reliability of the estimated quantitative information is presented to the user in this manner, thereby making it easier for the user to determine how much the quantitative information of the test substance estimated by the learning model can be trusted. In other words, it makes it possible to assist the user in determining the quantitative information of the test substance estimated by using the learning model.

### Second Embodiment

Subsequently, the second embodiment will be described. In the first embodiment, the correlation coefficient between the estimated value and the correct answer value is used as the reliability. In the second embodiment, a classification probability estimated by the classification learning model is used as the reliability.

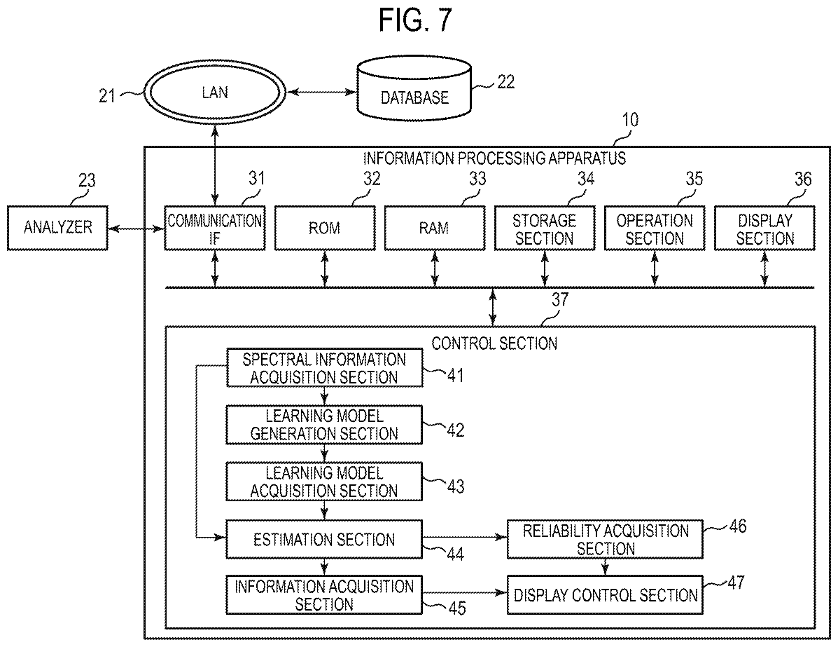

FIG. 7 is a diagram illustrating an overall configuration of an information processing system according to the second embodiment. Except for the following functional sections, the overall configuration of the information processing system and the hardware configuration and functional configuration of an information processing apparatus 10 in the second embodiment are the same as those of the first embodiment, and therefore the description thereof will be omitted.

The spectral information acquisition section 41 acquires an analysis result of a sample including at least a test substance and impurities, specifically, spectral information of the sample from the analyzer 23. In addition, the spectral information of the sample may be acquired from the database 22 in which the analysis result is stored in advance. Furthermore, the spectral information of the test substance is acquired in the same manner. The spectral information of the test substance is spectral information obtained in the case where a single test substance is present. Then, the spectral information acquisition section 41 outputs the acquired spectral information of the sample to the estimation section 44. Moreover, the acquired spectral information of the test substance is output to the learning model generation section 42.

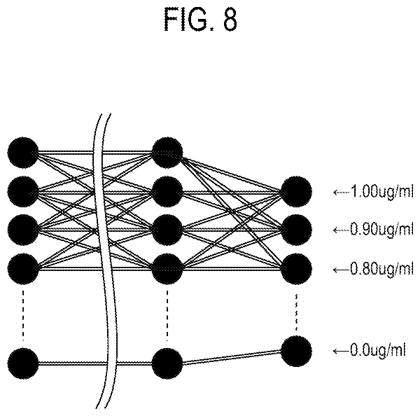

The learning model generation section 42 generates teacher data by using the spectral information of the test substance acquired by the spectral information acquisition section 41. Then, the learning model generation section 42 performs deep learning by using the teacher data and generates a learning model. The learning model generated in the second embodiment is a classification learning model. FIG. 8 is a diagram for describing the classification learning model in the second embodiment. As illustrated in FIG. 8, there is a plurality of nodes in the output layer, and each node corresponds to a class that indicates the quantitative information of the test substance. In addition, an output value of each node of the output layer indicates a classification probability. The detailed description of the generation of teacher data and the generation of a learning model is as described in the first embodiment. Then, the learning model generation section 42 outputs the generated learning model to the learning model acquisition section 43. The learning model generation section 42 may output the generated learning model to the database 22.

The estimation section 44 causes the learning model acquired by the learning model acquisition section 43 to estimate the quantitative information of the test substance contained in the sample by inputting the spectral information of the sample acquired by the spectral information acquisition section 41 into the learning model. In addition, the learning model acquisition section 43 also causes the learning model to estimate a classification probability of the estimated quantitative information. Further, the estimation section 44 outputs the estimated quantitative information to the information acquisition section 45 and outputs the estimated classification probability to the reliability acquisition section 46.

The reliability acquisition section 46 acquires the reliability of the quantitative information of the test substance acquired by the information acquisition section 45. The reliability in this embodiment is the classification probability estimated by the learning model. Therefore, the classification probability acquired from the estimation section 44 is used as the reliability of the quantitative information. The reliability acquisition section 46 outputs the acquired reliability to the display control section 47.

Subsequently, the processing procedure in the second embodiment will be described. The processing procedure for generating the learning model in the second embodiment is the same as the flowchart illustrated in FIG. 2 except for the following points.

In step S203, when the learning model generation section 42 generates the learning model, the learning model generation section 42 uses the classification learning model. Therefore, in learning with teacher data, the learning model is caused to learn to bring the output value of the concentration closer to 100%, where the output value has the largest output value (classification probability) among the nodes in the output layer, which corresponds to the quantitative information that is the correct answer data.

The processing procedure for acquiring the reliability in the second embodiment is the same as the flowchart illustrated in FIG. 3 except for the following points.

In step S302, the estimation section 44 causes the learning model to estimate the quantitative information of the test substance contained in the sample and the classification probability. The quantitative information corresponding to the node with the highest classification probability, which is the output value from the learning model, is assumed to be the quantitative information of the test substance contained in the sample. Then, in step S303, the reliability acquisition section 46 acquires the estimated classification probability as reliability. In step S304, the display control section 47 causes the display section 36 to display the quantitative information of the test substance contained in the sample estimated by the learning model in step S302 and the reliability acquired in step S303.

As described above, the classification probability of the classification learning model may be adopted as reliability. Similarly to the first embodiment, the second embodiment also enables assisting a user in determining quantitative information of a test substance estimated by using a learning model.

### Other Embodiments

Although the embodiments have been described in detail above, the present invention can be carried out as another form such as a system, apparatus, method, program, storage medium, or the like. Specifically, the present invention may be applied to a system composed of a plurality of devices by distributing the functions of the information processing apparatus, or may be applied to a device composed of a single device. In addition, in order to implement the functions and processes of the present invention on a computer, the program code itself installed in the computer also implements the present invention. Furthermore, the scope of the present invention also includes the computer program itself for implementing the functions and processes described in the above embodiments. In addition, when the computer executes a read program, the functions of the above-described embodiments may be implemented, or the functions of the embodiments may be implemented in combination with the OS or the like running on the computer on the basis of instructions of the program. In this case, the OS or the like performs a part or all of the actual processing, and the processing causes the functions of the above-described embodiment to be implemented. Further, the program read from the recording medium may be written into a memory provided in a function expansion board inserted in the computer or the function expansion unit connected to the computer, so that some or all of the functions of the above-described embodiments are implemented. The scope of the present invention is not limited to the above-described embodiments. At least two of the above-described plurality of embodiments may be combined.

### EXAMPLES

The present invention will be described in more detail below by giving examples and comparative examples. The present invention is not limited to the following examples. Examples 1 to 3 correspond to the first embodiment, and Example 4 corresponds to the second embodiment.

### Example 1

As Example 1, first, an example of applying the above-described data processing method to simulation data will be described to evaluate the advantageous effects of the method.

As test substance data (spectral information of a test substance), 11 types of normal distribution waveform data have been prepared with the median=250, the standard deviation=20, the peak height=0.0 to 1.0 in increments of 0.1.

Four normal distribution waveforms with the median, the standard deviation, and the peak height set to random numbers were added to each test substance data to use the result as sample data (spectral information of a virtual sample). For single test substance data, 1,000 types of sample data were prepared. Each sample data was combined with the peak height of the test substance data contained in each sample data to form 11,000 pieces of teacher data, and machine learning was performed by using the teacher data to generate a regression learning model. A fully connected neural network was used as a machine learning method, and a relu function and a linear function were used as activation functions. A mean squared error was used as a loss function, and Adam was used as the optimization algorithm. Iterative operations of about 100 epochs were required to obtain a sufficient quantitative accuracy.

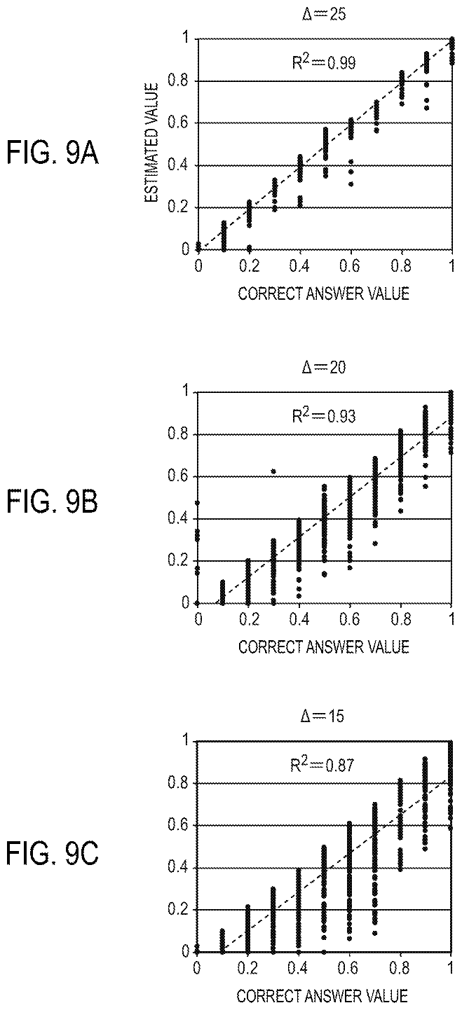

Subsequently, a large number of sample data created by the same method as the sample data were prepared. Among them, the peak of the sample data was focused on, which is located near the peak of the test substance data. The retention time that takes the maximum value of the peak is compared with the retention time that takes the maximum value of the peak of the test substance data, and 1,100 pieces of sample data with a time difference (Δ value) of 25 were selected. These pieces of sample data were input to the learning model to calculate the peak height of the test substance contained in the sample data. The simulation result of Example 1 is illustrated in FIG. 9A. FIG. 9A is a diagram with the horizontal axis as the peak height (correct answer value) of the test substance used in creating the sample data and the vertical axis as the peak height (estimated value) of the test substance obtained by using the learning model. As illustrated in FIG. 9A, the correlation coefficient between the correct answer value and the estimated value is 0.99, and this correlation coefficient was used as the reliability of the sample data whose Δ value is 25.

### Example 2

Example 2 is the same as Example 1 except that 1,100 pieces of sample data having a Δ value of 20 were selected, these were input to the learning model, and the peak height of the test substance contained in the sample data was calculated. The simulation result of Example 2 is illustrated in FIG. 9B. As illustrated in FIG. 9B, the correlation coefficient is 0.93, and this value was used as the reliability of the sample data whose Δ value is 20.

### Example 3

Example 3 is the same as Examples 1 and 2 except that 1,100 pieces of sample data with a Δ value of 15 were selected, these were input to the learning model, and the peak height of the test substance contained in the sample data was calculated. The simulation result of Example 3 is illustrated in FIG. 9C. As illustrated in FIG. 9C, the correlation coefficient is 0.87, and this value was used as the reliability of the sample data whose Δ value is 15.

### Example 4

In Example 4, machine learning was performed with teacher data prepared in the same manner as in Example 1 to generate a classification learning model. A fully connected neural network was used as a machine learning method, and a relu function and a softmax function were used as activation functions. A cross entropy loss function was used as a loss function, and SGD was used as an optimization algorithm. Iterative operations of about 100 epochs were required to obtain a sufficient quantitative accuracy.

Subsequently, 11 pieces of data were created by using the same method as the sample data. These were input to the learning model to classify the peak heights of the test substance contained in the sample data. In addition, the classification probability of each classification value was used as reliability.

The present invention enables assisting a user in determining quantitative information of a test substance estimated by using a learning model.

The present invention is not limited to the above embodiments, and various modifications and alterations can be made without departing from the spirit and scope of the present invention. Therefore, the following claims are attached to disclose the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising:
an information acquisition means for acquiring quantitative information of a test substance that is estimated by inputting spectral information of a sample containing the test substance and impurities into a learning model; and
a reliability acquisition means for acquiring reliability of the acquired quantitative information on the test substance.

2. The information processing apparatus according to claim 1, wherein the reliability acquisition means acquires the reliability by using the spectral information of the sample and the spectral information of the test substance.

3. The information processing apparatus according to claim 1, wherein:
the spectral information is a chromatogram; and
the reliability acquisition means acquires the reliability by using retention time identified on the basis of the spectral information of the sample and retention time identified on the basis of the spectral information of the test substance.

4. The information processing apparatus according to claim 1, wherein the reliability is a correlation coefficient between quantitative information of the test substance that is identified on the basis of the spectral information of the test substance and quantitative information of the test substance that is estimated by the learning model.

5. The information processing apparatus according to claim 1, wherein the reliability is a classification probability estimated by the learning model.

6. The information processing apparatus according to claim 1, further comprising a display control means for causing a display section to display the acquired reliability.

7. The information processing apparatus according to claim 6, wherein the display control means further causes the display section to display the acquired quantitative information of the test substance.

8. The information processing apparatus according to claim 1, wherein the learning model is a learning model learned by using a plurality of pairs of learning spectral information generated based on the spectral information of the test substance and the quantitative information of the test substance identified based on the spectral information of the test substance, as teacher data.

9. The information processing apparatus according to claim 8, wherein the learning spectral information is generated by using the spectral information of the test substance and random noise.

10. The information processing apparatus according to claim 9, wherein the random noise is a waveform obtained by combining a plurality of Gaussian functions.

11. The information processing apparatus according to claim 1, further comprising an estimation means for estimating the quantitative information of the test substance by inputting the spectral information of the sample into the learning model.

12. The information processing apparatus according to claim 1, wherein the spectral information is at least one of a chromatogram, a photoelectron spectrum, an infrared absorption spectrum, a nuclear magnetic resonance spectrum, a fluorescence spectrum, an X-ray fluorescence spectrum, an ultraviolet/visible absorption spectrum, a Raman spectrum, an atomic absorption spectrum, a flame emission spectrum, an emission spectroscopy spectrum, an X-ray absorption spectrum, an X-ray diffraction spectrum, a paramagnetic resonance absorption spectrum, an electron spin resonance spectrum, a mass spectrum, and a thermal analysis spectrum.

13. The information processing apparatus according to claim 1, further comprising an analytical means for performing analysis for use in acquiring the spectral information of the sample.

14. The information processing apparatus according to claim 13, wherein the analytical means performs at least one of chromatography, capillary electrophoresis, photoelectron spectroscopy, infrared absorption spectroscopy, nuclear magnetic resonance spectroscopy, fluorescence spectroscopy, X-ray fluorescence spectroscopy, visible/ultraviolet absorption spectroscopy, Raman spectroscopy, atomic absorption spectroscopy, flame emission spectroscopy, emission spectroscopy, X-ray absorption spectroscopy, X-ray diffractometry, electron spin resonance spectroscopy using paramagnetic resonance absorption, mass spectrometry, and a thermal analysis method.

15. The information processing apparatus according to claim 1, wherein the test substance is at least one of proteins, DNA, viruses, fungi, water-soluble vitamins, fat-soluble vitamins, organic acids, fatty acids, amino acids, sugars, agrichemicals, and environmental hormones.

16. The information processing apparatus according to claim 1, wherein the test substances is at least one of thiamine, riboflavin, N1-methylnicotinamide, N1-methyl-2-pyridone-5-carboxamide, 4-pyridoxine acid, N1-methyl-4-pyridone-3-carboxamide, pantothenic acid, pyridoxine, biotin, pteroylmonoglutamic acid, cyanocobalamin, and ascorbic acid.

17. The information processing apparatus according to claim 1, wherein the quantitative information is at least one of an amount of the test substance contained in the sample, a concentration of the test substance contained in the sample, the presence or absence of the test substance in the sample, a ratio of the concentration or amount of the test substance contained in the sample to the reference amount of the test substance, and a ratio of the amount or concentration of the test substance contained in the sample.

18. A control method of an information processing apparatus comprising:
an information acquisition step of acquiring quantitative information of a test substance that is estimated by inputting spectral information of a sample containing the test substance and impurities into a learning model; and
a reliability acquisition step of acquiring reliability of the acquired quantitative information on the test substance.

19. The control method of the information processing apparatus according to claim 18, wherein:
the spectral information is a chromatogram; and
the reliability acquisition step includes acquiring the reliability by using retention time identified on the basis of the spectral information of the sample and retention time identified on the basis of the spectral information of the test substance.

20. A computer-readable storage medium causing a computer to function as each means of the information processing apparatus according to claim 1.
